(19) United States
(12) Patent Application Publication
(10) Pub. No.: US 2004/0071827 A1
(43) Pub. Date: Apr. 15, 2004

(54) Energy food product comprised of inclusions containing physiologically functional ingredients

(75) Inventors: Jamie Troy, Columbia, NJ (US); Edward L. Rapp, Blairstown, NJ (US); Ralph Lee, Hampton, NJ (US); Jeannette Dido, Hoboken, NJ (US); Douglas Mann, Belvidere, NJ (US); Thomas Collins, Nazareth, PA (US); Kevin Rabinovitch, Hackettstown, NJ (US)

Correspondence Address: FITZPATRICK CELLA HARPER & SCINTO, 30 ROCKEFELLER PLAZA, NEW YORK, NY, 10112, US

(73) Assignee: Mars, Incorporated, McLean, VA

(21) Appl. No.: 10/272,571

(22) Filed: Oct. 15, 2002

(51) Int. Cl. A23L 1/30

(52) U.S. Cl. 426/72

(57) ABSTRACT

An energy food product is disclosed that is comprised of (a) a base energy food matrix; and (b) a plurality of inclusions dispersed within or on the base energy food matrix, wherein the inclusions contain at least one physiologically functional ingredient.

### BACKGROUND OF THE INVENTION

1. Field of the Invention

The present invention is directed to an energy food product having a plurality of inclusions that contain at least one physiologically functional ingredient. The energy food product minimizes undesirable organoleptic characteristics of physiologically functional ingredients by delivering the physiologically functional ingredients in the inclusions.

2. Related Background Art

Food products that identify themselves as energy food products are gaining in popularity among all consumers. The thought of eating a nutritious food product that is shelf stable and packaged in a portable form is appealing to most people, especially individuals who feel they need a functional benefit from the nutrients offered by such products. Other products, such as, granola bars and fruit snacks have gained in popularity by offering consumers natural food ingredients that are perceived to be nutritious.

However, the energy food products that are currently marketed are typically bars, which are made by mixing nutrient containing ingredients to form a homogeneous mass. The mass is then either extended or molded to form bar shape pieces that are dried or solidified. Many of these products do not appeal to consumers, who prefer more food like properties. Moreover, the homogeneity of the bar/extruded mass provides for a product that has a singular taste. This can lead to mediocre tasting products since functional ingredients, which often have undesirable taste attributes, are mixed in with other components thereby degrading the overall taste of the product leaving many of the presently marketed products with an unappealing taste, which causes many consumers to avoid them. A more appealing alternative is needed to provide consumers with the nutritional or functional benefits they seek in an energy food product that consumers find desirable with sensory variation and variety.

### SUMMARY OF THE INVENTION

The present invention is directed to an energy food product comprising (a) a base energy food matrix, and (b) a plurality of inclusions dispersed within or on the base energy food matrix, wherein the inclusions contain at least one physiologically functional ingredient.

The present invention also includes a method for making an energy food product, comprising the steps of (a) providing a base energy food matrix, and (b) dispersing a plurality of inclusions within or on the base energy food matrix, wherein the inclusions contain at least one physiologically functional ingredient.

### DETAILED DESCRIPTION OF THE INVENTION

For the purposes of the present invention, energy food products are food products that are shelf stable, in a portable form, and based on a 55 g serving size provides about 2 to about 55 g of carbohydrates, about 1 to about 5 g of fortification components (e.g., vitamins, minerals, antioxidants, herbs, etc.), about 5 to about 40 g of protein, about 2 to about 8 g of fat, about 170 to about 300 calories, and has a moisture content of at least about 3% by weight.

In addition, for the purposes of the present invention, the use of the term “functional” is understood to mean a physiologically functional ingredient.

The energy food products of the present invention are comprised of a base energy food matrix and a plurality of inclusions dispersed within or on a surface of the base energy food matrix. The inclusions contain at least one physiologically functional ingredient. Optionally, an edible coating may be applied to at least one surface of the base energy food matrix of the energy food product.

The base energy food matrix is one of the primary components in the energy food product and is comprised of at least one food component. The food component may be, for example, protein, starch, cocoa powder, grains, cereals, rice, syrups and the like.

Suitable protein sources include, but are not limited to, soy protein, milk protein, egg protein, peanut flour, nut meats, and combinations thereof.

The starch may be, for example, corn starch, oat, rice, wheat, barley, sorghum, and the like.

The base energy food matrix has from about 10 wt. % to about 90 wt. % of the food component based on the total weight of the energy food product. In a preferred embodiment, there is about 30 wt. % to about 70 wt. % of the food component.

A binder may be included in the base energy food matrix. The binder is applied to the food component to create or increase the tackiness and/or stickiness of the surface of the food component, so that the food component will adhere to other similar or dissimilar components, when necessary. Suitable binders include, but are not limited to, sugar syrup, corn syrup, fat, a gum solution, water, powders, and combinations thereof.

The binder is present in an amount of from about 10 wt. % to about 90 wt. % based on the total weight of the energy food product. Preferably, the binder is from about 30 wt. % to about 70 wt. % of the total weight of the energy food product.

In one embodiment, the base energy food matrix is formulated to be at least about 25% by weight fat, protein, or carbohydrate.

The other essential component of the present invention is inclusions, which are formulated to have at least one physiologically functional ingredient. A plurality of inclusions is dispersed throughout or spread on a surface of the base energy food matrix. The inclusions provide a means for isolating or concentrating the delivery of physiologically functional ingredients. This allows energy food products to be designed in a way that has several benefits. One benefit is the inclusion may be formulated with the physiologically functional ingredient to improve taste characteristics. For example, a physiologically functional ingredient may have an unpleasant or undesirable taste, which can be neutralized by masking the taste. Moreover, the inclusion will have its own unique taste, which is different from the base energy food matrix. Thus, providing the consumer with a wider range of taste sensations. Another benefit is that the inclusion may be formulated to improve the oxidative stability of the physiologically functional ingredient, which by itself may present stability issues. Yet another benefit is that process sensitive components, e.g., heat sensitive, shear sensitive, etc., may be incorporated into the inclusions. Still yet another benefit is that the inclusions can be formulated in such a way to provide desirable textural attributes. For example, the inclusions may be formulated to provide a crunchy textural feel. The inclusions have at least one physiologically functional ingredient and may be, for example, fat-based inclusions, carbohydrate-based inclusions, protein based inclusions, and the like.

The fat-based inclusions are characterized by having fat as the continuous phase. Non-limiting examples of fat-based inclusions include, chocolate, peanut butter, fat substitutes, and the like. Preferred fat-based inclusions are chocolate chips, peanut butter chips, and combinations thereof.

The protein-based inclusions of the present invention are at least about 25 wt. % protein. Non-limiting examples include, whey protein, soy protein, milk protein, egg protein, peanut flour, nut meats, vegetable protein, casein, and combinations thereof.

The carbohydrate-based inclusions of the present invention are at least about 25 wt. % carbohydrate. Non-limiting examples include, starch, sugar, gels, and combinations thereof. Moreover, the carbohydrate-based inclusions are preferably, panned inclusions, extruded gel pieces, friable carbohydrate pieces, sugar bits, extruded grain flour pieces and combinations thereof.

The inclusions may be, for example, agglomerates, capsules, compilations of ingredients, chunks, bits, drops, strands, strings, and the like. They may take on a variety of shapes, so long as the average particle size of the inclusions are from about 1 mm to about 13 mm. The preferred average particle size is from about 1 mm to about 6 mm.

In addition, it is contemplated that the inclusions of the present invention may be different from one another. That is, it is not necessary that the inclusions be the same. For example, the energy food product may contain inclusions that are fat-based inclusions and inclusions that are carbohydrate-based inclusions.

Optionally, the inclusions may be coated with a sugar syrup, hard fat, starch solution, or gum solution. The coating may be applied using any suitable means. For example, the coating may be applied by panning, spraying, dipping, enrobing, fluidized bed techniques, and the like.

The physiologically functional ingredient is an essential component of the energy food product of the present invention and is included to provide a physiological benefit, such as providing nutrients. Suitable physiologically functional ingredients include, but are not limited to, vitamins, minerals, fiber, antioxidants, herbal supplements, polyphenols, and the like. The vitamins and/or minerals can also be fat soluble and/or water soluble. In addition, the physiologically functional ingredient can also be an amino acid, enzyme, and the like.

The preferred vitamins are for example, vitamin A, vitamin C, vitamin D, vitamin E, vitamin K, and their derivatives and/or pro-vitamins. Preferred vitamins also include B vitamins such as, for example, biotin, folic acid, niacin, niacinamide, pantothenate, pyridoxine hydrochloride, riboflavin, thiamin hydrochloride, and the like. The preferred minerals include but are not limited to bromine, calcium, chromium, copper, iodine, iron, magnesium, manganese, phosphates, phosphorus, potassium, selenium, sodium, sulfur, and zinc.

Additionally, other physiologically functional ingredients include, for example, amino acids such as arginine, histidine, isoleucine, leucine, lysine, methionine, phenylalanine, threonine, tryptophan, valine, alanine, aspartic acid, glutamic acid, glutamine, glycine, serine, tyrosine, creatine, and the like. Moreover, the physiologically functional ingredients may be phytochemicals, sterols, lycopine, herbal supplements such as ginseng, guarana, yerba mate, and the like.

The inclusions are formulated to deliver a desirable amount of the physiologically functional ingredients. For example, the inclusions may be formulated to contribute at least about 5% by weight of the total weight of the physiologically functional ingredients in the energy food product. Preferably, the inclusions contribute at least about 20 wt. %, more preferably at least about 50 wt. %, and even more preferably at least about 75 wt. % of the total weight of the physiologically functional ingredients in the energy food product. In one particular embodiment, the inclusions are formulated to deliver about 100 wt. % of the total weight of physiologically functional ingredients in the energy food product.

In another embodiment, the inclusions are formulated to provide at least about 25 wt. %, preferably 50 wt. %, more preferably 75 wt. % and most preferably 100 wt. % of the total weight of one specific physiologically functional ingredient that is included in the energy food product.

Optionally, the inclusions may be formulated with ingredients or processed in such a way to improve product stability or other product features.

The inclusions are present in an amount of less than about 50% by weight of the base energy food matrix. About 5% to about 50% by weight in a preferred embodiment, more preferably about 10% to about 50% by weight, and most preferably about 10% to about 35% by weight. They may be combined with the base energy food matrix either by dispersing the inclusions within the base energy food matrix or by applying the inclusions on a surface of the base energy food matrix.

In a preferred embodiment, product stability and shelf life are ensured by designing the energy food product so that the total moisture content is less than about 15 wt. %, and preferably from about 3 wt. % to about 12 wt. %, based upon the total weight of the energy food product. The water activity of the energy food product is ideally less than about 0.6, and preferably less than about 0.5.

The energy food products of the present invention may also contain additional ingredients known to those skilled in the art in order to provide an organoleptically acceptable final product for consumption. For example, additional ingredients may include natural and artificial flavors, sweeteners, fruits, salt, flavor enhancers, color additives, emulsifiers, stabilizers, fats, preservatives, and the like.

The energy food product may take on a variety of forms. For convenience, it is preferred that the energy food product be shaped like a box, square, cylinder, string, pie, sphere, triangle, or any other portable format.

The present invention also includes a method for making an energy food product, comprising the steps of (a) providing a base energy food matrix, and (b) dispersing a plurality of inclusions within or on the base energy food matrix, wherein the inclusions contain at least one physiologically functional ingredient.

The dispersing step may be accomplished using any suitable mixing or spreading device so long as the inclusions remain substantially intact.

### EXAMPLE 1

TABLE 1
Energy Food Matrix

Ingredient

| | |
|---|---|
| Corn Syrup Blend | Consisting of High Fructose Corn Syrup and 63 DE |
| | corn syrup |
| Protein Blend | Consisting of Whey Protein Isolate, Calcium |
| | Caseinate, Soy protein isolate and peanut flour |
| Salt | Consisting of Vanillin, cinnamon and cocoa powder |
| Flavorings | |

TABLE 2
Physiologically Functional Ingredient Inclusion

| Ingredient | Wt. % |
|---|---|
| Chocolate Coating | 80.0 |
| Fortification Blend | 20.0 |
| | 100.0 |

TABLE 3

| Component | Wt. % |
|---|---|
| Energy Food Matrix | 80.0 |
| Physiologically Functional Ingredient Inclusions | 20.0 |
| | 100.0 |

The Physiologically Functional Ingredient Inclusions are made by combining the chocolate coating with a fortification blend in the ratio as set forth in Table 2. The mixture is tempered, deposited onto a steel band, and cooled to form what is commonly referred to as a “chocolate chip” shape.

The ingredients as set forth in Table 1 are mixed in a Z-blade style batch mixer to produce an energy food matrix. The physiologically functional ingredient inclusions are then added to the energy food matrix, in the ratio as set forth in Table 2 in the Z-blade mixer and mixed to produce a finished energy food product.

The finished energy food product matrix is then is cooled and formed into a slab using forming rolls. The slab is then further cooled, slit, cut into bar shapes, and packaged.

### EXAMPLE 2

The product as set forth in Example 1 with the following modification. The physiologically functional ingredient inclusions are peanuts that have been sprayed with a vitamin fortification blend in a sugar syrup carrier.

### EXAMPLE 3

TABLE 4
Fortification Slurry

| Ingredient | Wt. % |
|---|---|
| Glycerin | 17.7 |
| Fortification Blend | 32.4 |
| High Fructose Corn Syrup | 49.9 |
| | 100.0 |

TABLE 5

| Component | Wt. % |
|---|---|
| Energy Bar Matrix | 70.0 |
| Physiologically Functional Ingredient Inclusions | 10.0 |
| Fortification Slurry | 20.0 |
| | 100.0 |

The energy food matrix is produced as set forth in Example 1 with the modification that the physiologically functional ingredient inclusions are soy crisps that have folic acid added in an amount sufficient to deliver a percentage of the RDI in the finished product.

The majority of the fortification is added as a slurry, as set forth in Table 4. The fortification slurry, energy food matrix and physiologically functional ingredient inclusions are added to the mixer in the ratio as set forth in Table 5.

The finished energy food product matrix is then cooled and formed into a slab using forming rolls. The slab is further cooled, slit, cut into bar shapes, and packaged.

While the invention has been described above with reference to specific embodiments thereof, it is apparent that many changes, modifications, and variations can be made without departing from the inventive concept disclosed herein. Accordingly, it is intended to embrace all such changes, modifications, and variations that fall within the spirit and broad scope of the appended claims. All patent applications, patents, and other publications cited herein are incorporated by reference in their entirety.

What is claimed is:

1. An energy food product comprising:
(a) a base energy food matrix; and
(b) a plurality of inclusions dispersed within or on said base energy food matrix, wherein said inclusions contain at least one physiologically functional ingredient.

2. The energy food product according to claim 1, wherein said inclusions contribute at least about 5% by weight of the total weight of the physiologically functional ingredient in said energy food product.

3. The energy food product according to claim 1, wherein said inclusions contribute at least about 50% by weight of the total weight of the physiologically functional ingredient in said energy food product.

4. The energy food product according to claim 1, wherein said physiologically functional ingredient is selected from the group consisting of vitamins, minerals, fiber, antioxidants, herbal supplements, polyphenols, and mixtures thereof.

5. The energy food product according to claim 1, wherein said base energy food matrix is comprised of a binder and a food component.

6. The energy food product according to claim 5, wherein said binder is selected from the group consisting of sugar syrup, corn syrup, fat, a gum solution, water and mixtures thereof.

7. The energy food product according to claim 5, wherein said food component is selected from the group consisting of protein, starch, cocoa powder and mixtures thereof.

8. The energy food product according to claim 1, wherein at least about 25% by weight of said base energy food matrix is fat, protein, or carbohydrate.

9. The energy food product according to claim 1, wherein said inclusions have an average particle size of from about 1 mm to about 13 mm.

10. The energy food product according to claim 1, wherein said inclusions are selected from the group consisting of fat-based inclusions, carbohydrate-based inclusions, protein based inclusions, and mixtures thereof.

11. The energy food product according to claim 10, wherein said carbohydrate-based inclusions are selected from the group consisting of panned inclusions, extruded gel pieces, friable carbohydrate pieces, extruded grain flour pieces, sugar bits and mixtures thereof.

12. The energy food product according to claim 1, wherein said inclusions are coated with a sugar syrup, hard fat, starch solution or gum solution.

13. The energy food product according to claim 1, wherein said inclusions are present in an amount that is less than about 50% by mass of said base energy food matrix.

14. The energy food product according to claim 1, wherein said inclusions are present in an amount that is about 5% to about 50% by mass of said base energy food matrix.

15. The energy food product according to claim 1, wherein said inclusions are dispersed within said base energy food matrix.

16. The energy food product according to claim 1, wherein said inclusions are on a surface of said base energy food matrix.

17. The energy food product according to claim 1, wherein said inclusions are agglomerates, capsules, compilations of ingredients, chunks, bits, drops, strands, or strings.

18. The energy food product according to claim 1, further comprising an edible coating on at least one surface of said base energy food matrix.

19. The energy food product according to claim 1, wherein said food product takes the form of a box, square, cylinder, string, sphere, triangle, or pie.

20. A method for making an energy food product, comprising the steps of (a) providing a base energy food matrix, and (b) dispersing a plurality of inclusions within or on said base energy food matrix, wherein said inclusions contain at least one physiologically functional ingredient.
